(19) United States
(12) Patent Application Publication
(10) Pub. No.: US 2015/0271248 A1
(43) Pub. Date: Sep. 24, 2015

(54) METHOD AND SYSTEM OF DELIVERING CONTENT BASED ON PEER INTERACTIONS

(71) Applicant: ChaCha Search, Inc, Carmel, IN (US)

(72) Inventor: Eugene M. O'Donnell, Fishers, IN (US)

(21) Appl. No.: 14/664,042

(22) Filed: Mar. 20, 2015

Related U.S. Application Data
(60) Provisional application No. 61/968,441, filed on Mar. 21, 2014.

(51) Int. Cl. H04L 29/08; G06F 17/30; H04L 29/06

(52) U.S. Cl. CPC H04L 67/06; H04L 65/403; G06F 17/3053; H04L 67/10; G06F 17/30867

(57) ABSTRACT

A system and method of delivering content based on an interaction relationship between peers is described. An interaction is recorded when users respond to media and/or postings which may be presented as questions and responses. A relationship between a user action and actions of peers is used to determine targeting information for content such as postings of peers, and content which may be targeted to a topic, region, demographic, affiliation, affinity, and other parameters.

### BACKGROUND

1. Field of the Invention

The present invention is related to delivering content and more specifically to a method and system of selecting content which is delivered to a person based on activities by a person.

2. Description of the Related Art

In many types of services content is distributed to users based on user actions. Perhaps the oldest example is that of printed media publishing. A person views content based on selection of pages from an index. Content may include images, commercial promotions, and other information based on a page selected by a user and a publisher's decision.

In the interactive media environment, content may be presented in a similar spirit. However, content may be customized to a user's preferences. For example a user may activate a control which navigates to content, and other content may be presented based on historical information associated with a user. For example, a search engine may track previous queries by a user, location data, etc. to rank content, or so-called behavioral targeting may be used to collect information anonymously using ‘cookies’, ‘web beacons’, ‘pixels’, etc. which is then used to select content which is to be provided to a user.

Selection of content may be important to user satisfaction as well as to providing revenue which may support a service. Similarly selection of media may affect popularity of a service and usage as well as engagement with a site, or page which may have various beneficial effects. However conventional systems for targeting content based on user actions may have weaknesses. For example, behavioral targeting may be unable to know any or all user actions and thus may select content incorrectly. Behavioral targeting may not be able to determine whether a person has made a purchase and thus might present content related to a product or service a user has already purchased, or has rejected. Likewise recommendation of content based on pages visited such as social media sites may be in error due to a limited data set. For example, if a user indicates a preference for a posting on a site, or registers with a site this may not necessarily be a reliable indicator of user preferences.

For these and other reasons a method and system delivering content based on peer interactions would be greatly appreciated.

### SUMMARY

A system is implemented whereby a user may receive postings and may respond to postings. As used herein an original posting to which others may responds may be referred to as a post or “seed” or “origin” or “request”. A response to a posting may be referred to as an “answer” or “reply” or “response”. A response may be received associated with a posting and/or a reply.

A server device may receive postings and/or responses from users and may distribute content which may include postings to users. A user may receive a file from a server device which may include media and a seed as well as a number of responses. A user may take various actions responsive to receipt of a file. For example, a user may respond to a seed, may respond to an answer, may respond to a reply, and/or a reply to a reply, etc. A user may affirm an element of a file such as an origin, an answer and/or a reply. For example, a user may indicate agreement or disagreement with an item, or a user may elect to send an indicator of an item to others or a user may elect to visit a profile of a source of an item.

A data record which describes a sequence of interactions which are associated with an origin may be referred to as an “interaction diagram”. An interaction diagram may be used to select content which is provided when a request is submitted. An origin may be associated with a topic or category. If an interaction diagram indicates that a user has responded to an origin associated with a topic, content associated with the topic may be more likely to be presented. Similarly if a response of a user includes a keyword, a relationship between a keyword and an origin associated with the response may be used to select content to be presented.

Various aspects of an interaction diagram may be used to select content. For example, affirmation of content, peers selected by a user, peers associated with content which is affirmed by a user, peers which have affirmed content of a user, selection of content based on an order of presentation, a number of links between an origin and a response, a number of responses associated with an origin, etc. may be used to select content.

Various types of content may be presented. For example, an origin, a response, a reply, etc. which may include any suitable types of media may be presented. In some instances, content may be selected based on a bid associated with a criterion. For example, if a particular target audience is desired, a response, origin or reply which is directed to that audience may be favored if a bid is higher for an item associated with the criteria than other items associated with a selection criterion. A source of content may affect whether content is provided. For example, if a source of content is verified and/or is deemed reliable, preference may be given to items associated with a source. If a source has provided an origin to which a user has responded, a source may be more likely to be selected to provide content. Peer affirmation of content may affect a probability that an item is selected. For example, if a peer has a similar profile to a user and a peer affirms an item, an item and/or a source of an item may be more likely to be selected to provide content to a user deemed to be similar or different.

A user may submit a request using any suitable device. A user may receive content using any suitable device. Content may be presented to any number of devices associated with a user simultaneously or independently.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a flowchart of presenting content.

FIG. 3 is a flowchart of processing an interaction diagram.

FIG. 4 depicts an exemplary interaction diagram.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes one or more user devices, content provider devices and responder devices and may comprise a distribution server. A user device, responder system, and/or content provider system may be any type of computing device and may comprise a display device. A distribution server system may receive requests from user devices, responder devices, and content provider systems and may provide content to them.

As used herein, a “request” or query or question means a request for information, products, and/or services. A request or query may include various types of media, and may be provided by any system or device which may establish communication with a server and/or other devices accessible via a network such as the internet, a private network and/or a combination thereof.

A “user” is a person who submits a request and may receive any type of information responsive to a request. A user may be any person or entity. A “responder” or answerer may be any person or entity who elects to receive a request and provide a response. A “content provider” may be any person or entity which may provide media content which may be distributed to a user and/or a responder.

A responder may receive requests in various ways. A responder may elect to receive requests based on one or more categories, keywords or topics assigned to a responder. Profile information associated with a responder may be used to determine when a request is directed to a responder. A ranking of a responder may affect whether a request is directed to a responder. An editor may select a responder to whom a request is directed. A peer is any user other than a user.

Content may be selected to be delivered to a user and/or a responder. Content may include video, images, audio, text, metadata, and/or any combination of media which is compatible with a user device. Content may include requests of users, responses, replies, etc. Content may be selected based on a relationship between users and/or responders which may be recorded in an interaction record. Interactions may include information of a user who posts an initial request, users who have responded to an initial posting, users who have responded to responses and/or replies to a seed request.

A response to a seed or root request may indicate that a user is interested in a topic represented by a seed. A response to a reply to a seed may indicate that a user is interested in a topic of the seed and/or a topic of a reply. A reply to a response may be accorded a different weight than a response to a seed. Any number of answers and responses may be associated with a seed. A response may include media such as text, images, metadata, tags, video, audio, etc. A response and/or reply may indicate concurrence or dissent with a posting which may affect a rating and/or ranking of a user associated with a seed and/or response. Relationships between users may be evaluated based on an interaction. Multiple responses by a user to postings by a different user or peer may be used to determine whether a posting of the user will be provided to the different user. Content and/or postings may be targeted based on an interaction. For example, if a user has responded to multiple postings associated with a topic, content associated with the topic may be more likely to be presented to the user.

An interaction may comprise any number of responses and/or users, responders, content, etc. An interaction may include temporal information. An interaction after a time period has passed may indicate a stronger and/or weaker affinity for a topic and/or user. A number of responses to a posting may affect strength of an association. For example, if a larger number of responses is received, peer interaction strength may be decreased or increased. If a user responds to responses of another user associated with a topic and the responses include content associated with a topic, an association between the users and the topic may be increased. If a number of responses are sequential interactions between two users a strength of association of the users to a topic may be decreased or increased.

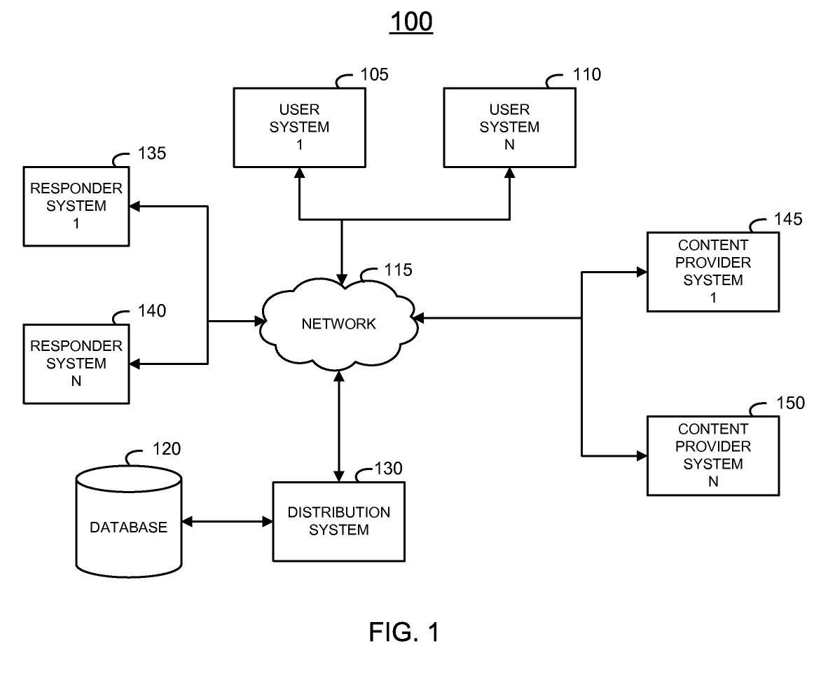

As illustrated in FIG. 1, system 100 includes user systems 105, 110, a network 115 such as the Internet, a distribution system 130, a database 120, which may comprise various records, responder systems 135, 140, and content provider systems 145, 150. A user system and/or a responder system may be operated by a user.

While only a few systems associated with a user, a responder, a content provider and a distribution system are depicted in FIG. 1 it is within the scope of the disclosure for multiple systems for a user, a responder, a content provider and a distribution service to be utilized. In particular it is envisioned that many user, responder, content provider and distribution systems may be implemented. The distribution system 130 may be a composed of many components as described further herein.

The network 115 may be a global public network of networks (i.e., the Internet) and/or may consist in whole or in part of one or more private networks and communicatively couples the user systems 105, 110, the responder systems 135, 140 and the content provider systems 145, 150 with the other components of the system 100 such as the distribution system 130, and the database 120. The network 115 may include one or more wireless networks which may enable wireless communication between the various elements of the system 100. For example, the distribution system 130 may receive messages which may be routed via a wireless network controlled by a wireless service to the user systems 105, 110. A wireless service may receive messages from the responder systems 135, 140 via a wireless network which is a part of the network 115, and provide the messages to the distribution system 130 via an internet connection which is part of the network 115.

The distribution system 130 allows interaction to occur among the user systems 105, 110, the responder systems 135, 140 and the content provider systems 145, 150. For example, a request can be transmitted from the user system 105 to the distribution system 130, which may provide information obtained from the database 120, which may include an advertisement to the responder system 140. Any type of communication between users, and responders may be mediated and/or facilitated by the distribution system 130, and/or other elements of the system 100.

The distribution system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the distribution system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the responder systems 135, 140, the content provider systems 145, 150 and the distribution system 130 may include equipment, software, systems and personnel required to send and/or receive messages between user systems 105, 110, the responder systems 135, 140, the content provider systems 145, 150, and/or the distribution system 130 using the network 115. The database 120 includes information which may allow the distribution system 130 to establish communication between any or all of the elements of the system 100.

A user system, a responder system, a content provider system and/or a distribution system may be a desktop, portable, or tablet computer using an operating system such as Windows®, iOS®, Android®, etc., a mobile phone, a smart phone, a PDA, a server system, a landline phone, a specialized communication terminal, a terminal connected to a mainframe, or any other suitable communication hardware and/or system. The distribution system 130, a user system and/or a responder system may include one or more servers, computers, etc. For example, servers such as the PowerEdge® 2900 by Dell, or the BladeCenterJS22 by IBM, or equivalent systems might be used to implement elements of the distribution system 130. The distribution system 130 and/or the database 120 may utilize an operating system (OS) such as Microsoft Windows®, Linux, iOS®, Android®, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems and/or to implement the distribution system 130.

A user may be identified by the distribution system 130. When a user system accesses the distribution system 130 a user may be identified based on security information provided to the distribution system 130. A user may receive responses based on a number of requests composed by a user.

A user may be required to register with the distribution system 130. As part of a registration process, at least one communication method is associated with a user. In at least one embodiment, a user may register with the distribution system 130 and establish a username and password which are associated with the user. A user may login to the distribution system 130 using a web browser functionality of the user system 110 in order to communicate with the distribution system 130. One or more identifiers may be assigned to a user and may be used to identify content such as requests, responses, opinions, etc., associated with a user. A user may provide profile information such as personal information, geographic, background, affiliation, demographic, interest, category, etc. information. A user may provide information required to provide payment. A user may register using a Single Sign On (SSO) facility such as credentials from a distribution system such as the Facebook® or LinkedIn® services. Profile information such as communication information, personal data, etc. may be obtained based on a user sign-in credential, and/or content of a user system.

A responder may be required to register with the distribution system 130. As part of a registration process, at least one communication method is associated with a responder. In at least one embodiment, a responder may register with the distribution system 130 and establish a username and password which are associated with the responder. A responder may login to the distribution system 130 using a web browser functionality of the responder system 145 in order to communicate with the distribution system 130. One or more identifiers may be assigned to a responder and may be used to identify content associated with a responder. A responder may provide profile information such as personal information, geographic, background, affiliation, demographic, interest, category, etc. information. A request may be directed to a responder based on any information associated with a responder. A responder may elect to block requests based on factors such as content, originator, etc. A responder may provide information required to provide payment to a responder.

When a responder is registered with the distribution system 130 the responder may have access to content available from the distribution system 130. This may include sponsored content provided by advertisers, content provider systems, requests, response, data indicated in the database 120, requests of users, topics, etc. A responder may have access privileges based on factors such as experience of the responder, ratings of responses of a responder, revenue obtained based on works of a responder, etc.

A content provider may be required to register with the distribution system 130. As part of a registration process, at least one communication method is associated with a content provider. In at least one embodiment, a content provider may register with the distribution system 130 and establish a username and password which are associated with the content provider. A content provider may login to the distribution system 130 using a web browser functionality of the content provider system 145 in order to communicate with the distribution system 130. One or more identifiers may be assigned to a content provider which may be used to distribute content such as requests, replies, responses, seeds, advertisements, images, etc., to a content provider.

Records may be maintained in the database 120 which may be used to record the status of various items. Such records may be used to aid the targeting of content provided by content providers such as advertisers and/or publishers, track activities of users, determine usage history of websites, publisher content, and advertisements, etc. For example, a user may activate an indicator distributed by a publisher, which may cause a request to be received by the distribution system 130, which may obtain website activity information which may be used to select content to be provided to a user responsive to a request. Similarly, the database 120 may include records of activities of users and responders regarding postings.

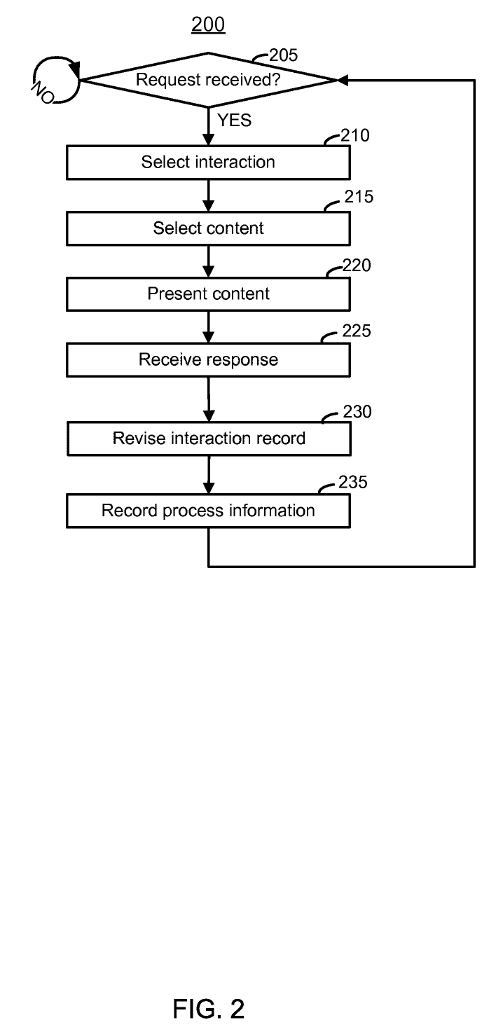

As illustrated in FIG. 2, a process 200 for selecting content is provided. The process 200 may be performed in whole or in part by any suitable element of the system 100 (FIG. 1). In at least one embodiment, the process 200 is operative on a server associated with the distribution system 130 and/or the user device 110.

In operation 205 (FIG. 2) a determination is made as to whether a request is received. If it is determined in operation 205 that a request is not received, control remains at operation 205 and process 200 continues. If it is determined in operation 205 that a request is received, control is passed to operation 210 and process 200 continues. A request may be any communication which may receive content in response to a communication.

The determination in operation 205 may be made using various criteria. In at least one embodiment, if a message is received at a system associated with the distribution system 130 (FIG. 1), it may be determined that a request is received. For example, if a GET request indicating an identifier of a user is received at a server associated with the distribution system 130, it may be determined that a request is received. Any type of message may be received which may indicate that a request is received. For example, reception of an SMS message, a mobile web message, a message from an App, etc., may be used to determine whether a request is received. A request may be internal to a user device. For example, if a user sets a time or a condition which may be detected based on information provided by a user device, it may be determined that a request is received.

In operation 210 an interaction is selected. An interaction may be selected in various ways. Records of interactions by a user associated with a request may be selected. Records of interactions may be selected based on a profile associated with a request. If a request is associated with a posting, interactions associated with a topic and/or other metadata of a posting may be selected. Interactions of users associated with a topic may be selected if a request is associated with a topic. Any suitable criteria may be used to select an interaction. Control is passed to operation 215 and process 200 continues.

In operation 215, content is selected. Content may be selected based on various criteria. Content may include any suitable type of targeting information such as keywords, demographic, geographic, location, and/or other targeting data as is well known in the art. Information of interactions may be used alone and/or in combination with other targeting data to select content. For example, if users who frequently interact with a user have accepted content, that content may be selected for a request associated with a user. If a user has been determined to interact with requests associated with a particular topic to which content is targeted, that content may be more likely to be selected for a request associated with a user, which may override content of a request. If a user is determined to interact with users and/or content associated with a geographic location, demographic, affiliation and/or other attribute content may be selected which is targeted to an attribute. If content is associated with affirmation and/or dissent associated with users with whom a user has interacted, the content may be more likely to be selected. Any combination of targeting information and/or interactions may be used to select content. Content may be selected based on any number of users who may be associated with a request. Control is passed to operation 220 and process 200 continues.

In operation 220, content is presented. Any type and/or amount of content may be presented. Content may include responses associated with a request, promotional content, seed postings, notifications of activities, suggestions of content, users, etc. Content may be presented in any suitable manner. Content may be presented in an order based on a rating, ranking, type, etc. associated with content and/or a source of a request. Control is passed to operation 225 and process 200 continues.

In operation 225, a response is received. A response may include actions such as a reply, an affirmation, a dissent, a view of media and/or additional content, activation of a feature in a user interface, etc., which relates to any and/or all content provided. A response may indicate any number of inputs regarding content. A response may be implied, such as a timeout or lack of action. Control is passed to operation 230 and process 200 continues.

In operation 230, an interaction record is revised. Information regarding a response may be used to revise an interaction record such as an interaction diagram or map. Actions such as responses to a seed, replies to responses, affirmations and/or dissents, etc. may be added to a record of an interaction. A rating and/or ranking of content, a user, a topic, a keyword, a category, etc., may be adjusted based on an interaction. Control is passed to operation 235 and process 200 continues.

In operation 235, process information is recorded. Information of a request, a user, a responder, a publisher, a website, an advertiser, content, targeting parameters, user actions, compensation of a publisher, responder, editor, advertiser, etc., a rating, a ranking, etc. may be recorded. In at least one embodiment, process information is recorded in the database 120 (FIG. 1). Control is passed to operation 205 and process 200 continues.

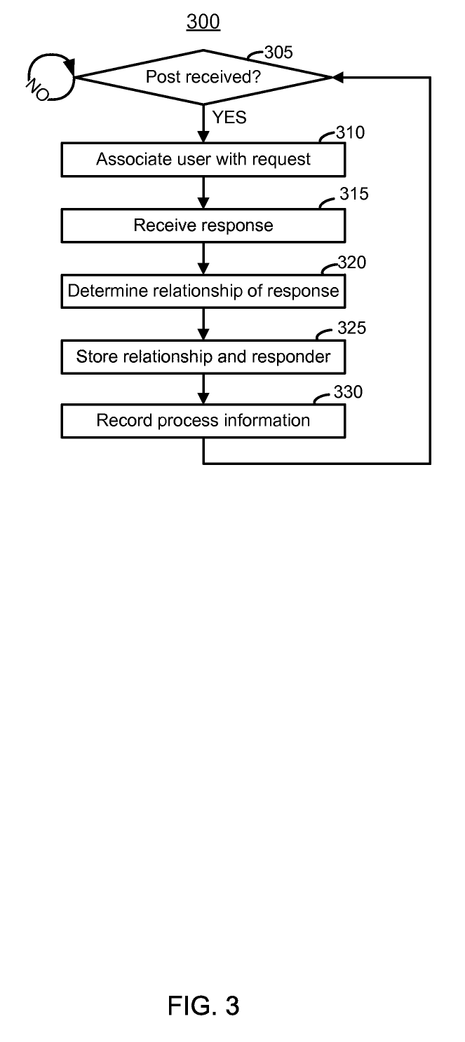

As illustrated in FIG. 3, a process 300 for recording an interaction is provided. The process 300 may be performed in whole or in part by any suitable element of the system 100 (FIG. 1). In at least one embodiment, the process 300 is operative on the distribution system 130.

In operation 305 (FIG. 3) a determination is made as to whether a post is received. If it is determined in operation 305 that a post is not received, control remains at operation 305 and process 300 continues. If it is determined in operation 305 that a post is received, control is passed to operation 310 and process 300 continues.

The determination in operation 305 may be made using various criteria. In at least one embodiment, if a message is received at a system associated with the distribution system 130 (FIG. 1), it may be determined that a post is received. For example, if a GET request indicating an identifier of a user is received at a server associated with the distribution system 130, it may be determined that a post is received. Any type of message may be received which may indicate that a post is received. For example, reception of an SMS message, a mobile web message, a message from an App, etc., may be used to determine whether a post is received. A post may be internal to a user device. For example, if a user sets a time or a condition which may be detected based on information provided by a user device, it may be determined that a post is received.

In operation 310 a user is associated with a request. For example, an identifier of a posting may be associated with a user device, a login ID, etc., which may identify a user. A post may indicate a type of activity which is received from a user. For example, a post may indicate that a response is directed to a particular seed or basis posting and/or a response or reply associated with a root. Control is passed to operation 315 and process 300 continues.

In operation 315 a response is received. A response may comprise any type of media. A response may include an affirmation or dissent. A response may be indicated by a message which is received as a post. A posting may include delivering content to others. For example, a user might elect to share content of a root and/or a response with others via a message such as an SMS, email, posting to a website or other social media, etc. Control is passed to operation 320 and process 300 continues.

In operation 320, a relationship of a response is determined. A relationship may be based on a post to which a response is directed. For example, if a user has selected a control which indicates a particular action, a response may be related to a target posting as well as other postings which are related to the target. For example, if a user responds to a root posting, a relationship may be established with other answers associated with the root posting. If a response is a highly ranked response, has been viewed by a user, etc. a response may be more or less strongly related to a post. Control is passed to operation 325 and process 300 continues.

In operation 325 a relationship and a responder are stored. A stored relationship between a responder and a response may be recorded in any suitable manner. In an embodiment, a record may be updated which is associated with a root posting. Content of a response and a type of response may be stored. Control is passed to operation 330 and process 300 continues.

In operation 330, process information is recorded. Information of a request, a user, a responder, a publisher, a website, an advertiser, content, targeting parameters, user actions, etc., a rating, a ranking, etc. of an item may be recorded or persisted. In at least one embodiment, process information is recorded in the database 120 (FIG. 1). Control is passed to operation 305 and process 300 continues.

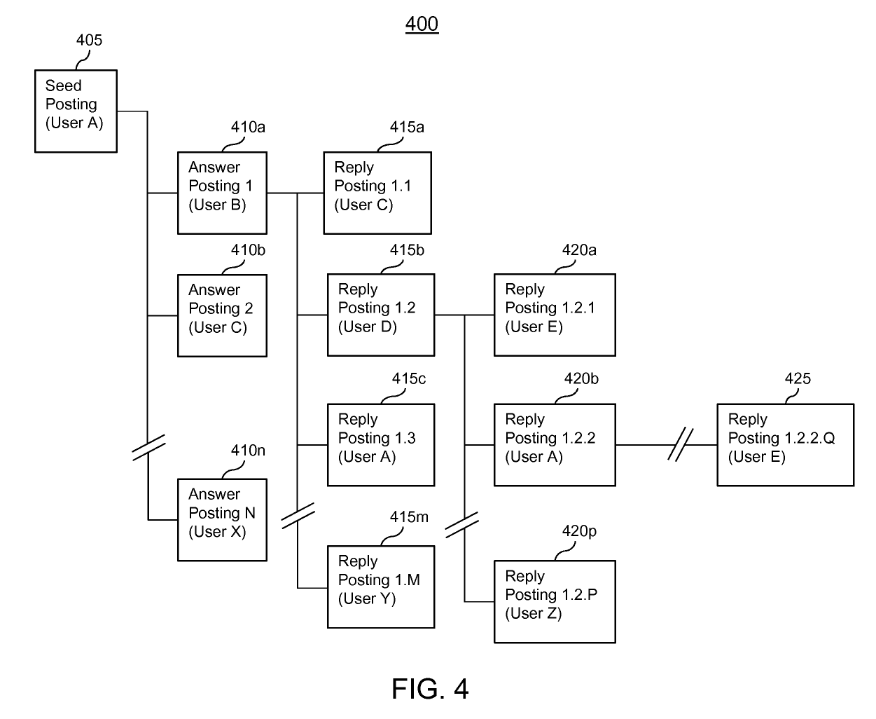

An exemplary interaction diagram 400 is illustrated with respect to FIG. 4. While a diagram is used for the purposes of illustration, links and information indicated in the interaction diagram 400 may be stored in any suitable manner. For example, a database record might be created which indicates information contained in interaction diagram 400. An interaction may be initiated by a seed posting 405 which is associated with a user (i.e., User A). A seed posting may be associated with metadata and/or may be analyzed to determine any type of information regarding content of the seed posting 405. Likewise, information regarding a user providing the seed posting 405 may be determined.

Responsive to the seed posting 405 a number of answer postings may be received. As illustrated the answer postings 410a, 401b and 410n may have been received responsive to the seed posting 405. An answer posting may be determined to have a weight which is related to the number of links between the seed posting 405 and other answer postings. Answer postings may be associated with a user. For example, the answer posting 410b is associated with User C. A future posting by User A might be more likely to be presented to User C as User C has responded to the seed posting 405. Likewise if content is associated with a topic and/or other targeting information which is related to the seed posting 405, content may be ranked higher and/or may be more likely to be presented to User C. Any number of answer postings may be received from any number of users. An answer posting may include an affirmation or dissent (e.g., like/dislike) which comprises no other content. A relationship to a root posting may be modified based on an answer posting comprising media, a number of answer postings by a user, a number of affirmations or dissents associated with an answer posting, content of an answer, a number of replies associated with an answer, etc.

Responsive to an answer posting a number of reply postings may be received. As illustrated in FIG. 4, the reply postings 415a, 415b, 415c, and 415m have been received responsive to the answer posting 410a. As User A has responded via the reply posting 415c to the answer posting 410a, this may indicate a stronger interest and thus a stronger relationship between User A and User B than for example, User C. Such a relationship may be generalized and/or may be associated with a topic and/or other information of the seed posting 405 and/or the answer posting 410a. As with answer postings, reply postings may be used to evaluate relationships based on a number of reply postings associated with an answer posting, a ranking of an answer posting and/or a reply posting, a number of affirmations and/or dissents, etc. A weighting associated with reply posting and a root posting may be lower than a weighting associated with a seed posting and a reply posting. For example, the reply posting 415m by User Y may cause User Y to be linked to User B, but less strongly linked to User A, in particular if User Y did not view the reply posting 415c by User A.

Responsive to a reply posting, various levels of reply postings may be received. Secondary reply postings 420a, 420b, and 420p may be received responsive to the reply posting 415b. Any reply posting may receive a lower level reply posting. A chain of reply postings such as the subsequent level reply posting 425 may have any number of intervening postings as indicated by the discontinuity of the linkage lines in FIG. 4. A relationship of interactions may be used to strengthen and/or diminish a rating, ranking, etc. between users associated with postings. For example, a relationship between User E and User A might be determined based on the secondary reply postings 420a and 420b and the subsequent level reply posting 425.

While a limited number of replies and levels of replies has been used for purposes of illustration in FIG. 4 no limitation is implied. Any number of levels and types of postings may be used in an interaction diagram. While a single interaction diagram is illustrated in FIG. 4 it is expected that many interaction diagrams will be created and analyzed in the operation of the embodiments. A relationship between a user and other users, metadata, and/or other forms of targeting information may be established based on any number of interactions. For example, a large number of interactions may be analyzed to determine a relationship based on interactions. Likewise, temporal information such as how recently a response has occurred, how recently an interaction has occurred, etc., may be used to determine a ranking and/or probability that content will be provided to a user.

Using the method and systems described herein content is delivered based on interactions by users. A file may be presented to a user. A user response to a file is received. Content is selected based on interactions between users. Selected content is presented to a user when a request is received form a user. A topic associated with a file which has been involved in an interaction of a user may be used to select content. A keyword indicated in a file and media received from a user may be used to select content. An interaction relationship may be determined based on a posting to which responses of users are directed. An interaction relationship may be identified based on a preference indicated by a user regarding a posting which has been directed to a file and/or a response.

A user who responds to a user may be referred to as a peer. An interaction relationship may include information of a medium included in a response. For example if a response comprises and image, video, audio, etc. an interaction relationship may be strengthened. Similarly duration of a response may indicate a stronger or weaker interaction. If a user affirms, dissents or disagrees with a peer an interaction relationship may be modified. Content which has been presented to a peer who has been affirmed by a user may be more likely to be selected to be presented to a user. Similarly, content associated with a source of a file and/or content linked to a peer who has been selected by a user may be more likely to be presented to a user.

A relationship between a file and a response of a user may be used to select content. For example, if a response is a direct reply to a posting, an interaction relationship may be stronger than if a posting is a reply to a direct reply. As a response is progressively removed from an original posting an interaction relationship may be reduced, which may make content associated with an original file or posting less likely to be selected. Content which is selected may include responses of peers selected based on an interaction relationship. An action of a user responsive to selected content may modify an interaction relationship. Content selection may be affected by a bid associated with content and/or other targeting information derived based on an interaction relationship or interaction diagram. Content selection may be performed based on geographic, demographic, affiliation, etc. information of users associated with an interaction diagram.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of selecting and delivering content via a network comprising:
presenting a file to a user;
receiving a response of a user comprising media;
selecting content based on an interaction relationship of users; and
providing the content when a request is submitted.

2. The method of claim 1 further comprising:
creating the file based on a topic; and
selecting the content based on the topic.

3. The method of claim 1 further comprising:
determining a keyword based on the file and the media; and
selecting the content based on the keyword.

4. The method of claim 1 further comprising:
identifying the interaction relationship including information of a posting to which responses are directed.

5. The method of claim 1 further comprising:
identifying the interaction relationship including a preference indicated by the user associated with a response.

6. The method of claim 1 further comprising:
creating the interaction relationship including based on a medium indicated by a response of the user.

7. The method of claim 1 further comprising:
including in the interaction diagram a weighting associated with a peer and the user.

8. The method of claim 7 further comprising:
performing a ranking based on peer activities which a user has affirmed; and
presenting the content to a peer.

9. The method of claim 7 further comprising:
performing a ranking based on peer activities which a user has affirmed; and
presenting the content to a peer based on a source of the file.

10. The method of claim 7 further comprising:
performing a ranking based on peer activities which a user has affirmed;
presenting the content to the user based on a source of the file and a link to a peer; and
establishing the link to the peer based on a selection by the user.

11. The method of claim 1 further comprising:
including in the interaction diagram data which describes a relationship between a posting which creates the file and the response.

12. The method of claim 11 further comprising:
adjusting a rank used to select the content based on the data by reducing a rank of a topic of the file when the data indicates a response is far from the posting.

13. The method of claim 1 further comprising:
presenting the content to a peer of the user when the peer submits the request and the request is directed to a subject matter of the file.

14. The method of claim 1 further comprising:
presenting a reply of a source associated with the interaction diagram as the content.

15. The method of claim 1 further comprising:
presenting a reply of a responder as the content; and
choosing the responder based on an affirmation of the responder.

16. The method of claim 1 further comprising:
presenting a posting of a peer as the content; and
adjusting the selection of the content based on an action of a recipient of the content.

17. The method of claim 1 further comprising:
presenting a posting as the content; and
adjusting the selecting of the content based on a bid associated with the posting.

18. The method of claim 1 further comprising:
presenting a posting of a peer as the content; and
adjusting the selection of the content based on a profile of a person affirming the posting.

19. A system, comprising:
a distribution system presenting a file to a user, receiving a response of a user comprising media, selecting content based on an interaction diagram associated with the file, and providing the content when a request is submitted.

20. A non-transitory computer readable medium storing therein a program for causing a computer to execute an operation including creating media content, comprising:
presenting a file to a user;
receiving a response of a user comprising media;
selecting content based on an interaction diagram associated with the file; and
providing the content when a request is submitted.
